(19) United States
(12) Patent Application Publication
(10) Pub. No.: US 2008/0190066 A1
(43) Pub. Date: Aug. 14, 2008

(54) Mobile compartment system

(76) Inventor: David E. Rajewski, Spokane, WA (US)

Correspondence Address: WELLS ST. JOHN P.S., 601 W. FIRST AVENUE, SUITE 1300, SPOKANE, WA, 99201, US

(21) Appl. No.: 11/706,077

(22) Filed: Feb. 14, 2007

(51) Int. Cl. B62D 53/00

(52) U.S. Cl. 52/588.1; 414/474; 29/428

(57) ABSTRACT

This invention in some embodiments includes a mobile compartment system with a first panel member and a second panel member, each with a first side, a second side, a first end, a second end, a first edge, a second edge, the first edge including a male edge connector and the second edge including a female edge connector; and wherein the male edge connector of a first panel member and a female edge connector of the second panel member are configured to operatively attach together.

### CROSS REFERENCE TO RELATED APPLICATION

This application does not claim priority from any other application.

### TECHNICAL FIELD

This invention relates to a compartment system primarily for use in or on trucks and trailers (or other applications) providing what is referred to by many as the box, trailer or enclosure system.

### BACKGROUND OF THE INVENTION

There are numerous types and configurations of enclosures, boxes or compartments which are utilized as trailer enclosures, as truck boxes or truck trailers, and the like. The prior art systems traditionally include some type of framework and a skin or other siding material which is attached to the framework. In a typical construction, the framework may be constructed, and thereafter the siding would be attached to the framework. The doors and windows would have to be pre-planned ahead of time so that the appropriate structure or framework was present to support the doors, the wiring and other accessories which may later be installed within the enclosure. The location, installation and configurations for the lighting and other electrical outlets and accessories required by the trailer would typically be customized to the trailer, depending upon the application.

Due to the nature of the construction of most of these trailers, they are built lightweight and not as structurally sound as desired for many applications. Furthermore, the need to customize the trailer exterior and/or framework for doors and other openings, which may make it more expensive and more tedious than necessary to build a framework to install said openings. Once these openings are installed in a traditional framework, the overall trailer is not as strong and typically does not hold its shape as much as desired, but instead there is relative movement and doors do not open and close consistently over time.

The prior art compartments are further not sufficiently strong nor do they provide an easy mechanism for attaching accessories to the sidewalls without the addition of other structural elements to provide further support for the mechanism, accessory, or attachment.

It is therefore an object of some embodiments of this invention to provide a truck box, compartment or enclosure which provides an integrated structural support with siding on both the inside and the outside.

It is a further object of some embodiments of this invention to provide a truck or trailer compartment in which door openings and other openings may be cut right into the wall with the door or other object connected to the wall at the desired location and not necessarily where a support is already located or must be placed.

It is a still further object of some embodiments of this invention to provide a truck compartment which includes conduits or pathways for electrical wiring and other components which may be easily accessed and re-routed.

While the invention was motivated in addressing some objectives, it is in no way so limited. The invention is only limited by the accompanying claims as literally worded, without interpretive or other limiting reference to the specification, and in accordance with the doctrine of equivalence. While the invention was motivated in addressing some objectives, it is in no way so limited. The invention is only limited by the accompanying claims as literally worded, without interpretative or other limiting reference to the specification, and in accordance with the doctrine of equivalents.

Other objects, features and advantages of this invention will appear from the specification, claims, and accompanying drawings which form a part hereof. In carrying out the objects of this invention, it is to be understood that its essential features are susceptible to change and design and structural arrangement, with only one practical and preferred embodiment being illustrated in the accompanying drawings, as required.

### BRIEF DESCRIPTION OF THE DRAWINGS

Preferred embodiments of the invention are described below with reference to the following accompanying drawings:

FIG. 1 is an elevation view of one embodiment of a mobile compartment system contemplated by this invention;

FIG. 2 is a side elevation view and a rear view of the truck and box configuration illustrated in FIG. 1;

FIG. 3 is a top view of the mobile compartment system illustrated in FIG. 1;

FIG. 4 is detail 4 from FIG. 3;

FIG. 5 is an elevation view of an embodiment of the mobile compartment system contemplated by this invention as part of a trailer;

FIG. 6 is a perspective view of one embodiment of a panel member which may utilized in practicing this invention;

FIG. 7 is top cross-sectional view 7-7 from FIG. 6 of the panel member illustrated in FIG. 6;

FIG. 8 is detail 8 from FIG. 7;

FIG. 9 is detail 9 from FIG. 7;

FIG. 10 is a cross-section view of one embodiment of how adjacent ends of panel members may be assembled together;

FIG. 11 is a cross-section view of the ends of two adjacent panel members partially assembled together;

FIG. 12 is a cross-section view of the ends of two adjacent panel members substantially pressed together;

FIG. 13 is a cross-section view of two adjacent panel members operatively attached to one another, as contemplated by the invention;

FIG. 14 is a perspective view of an embodiment of a corner member which may utilized in practicing this invention;

FIG. 15 is cross-section view 15-15 from FIG. 14;

FIG. 16 is cross-section view 15-15 from FIG. 14, with an accessory conduit within the inner corner;

FIG. 17 is a cross-section view of the embodiment of a corner member illustrated in FIG. 15, with the embodiment of panel members illustrated in FIG. 6 operatively attached thereto;

FIG. 18 is a top view of the perimeter of a mobile compartment system contemplated by this invention before the top has been placed there over;

FIG. 19 is a partial top view of an embodiment of the invention including sidewalls and a base floor;

FIG. 20 is an exemplary elevation view illustrating how in one embodiment of the invention that adjacent panel members illustrated in FIG. 6 may be longitudinally slid together to interconnect them;

FIG. 21 is an elevation view of the adjacent panel members illustrated in FIG. 20 partially slid together;

FIG. 22 is an elevation view of the panel members illustrated in FIG. 20 fully assembled or slid together; and

FIG. 23 is an elevation view of another embodiment of the invention wherein the wall panel members are horizontally oriented.

### DETAILED DESCRIPTION OF THE PREFERRED EMBODIMENTS

Many of the fastening, connection, manufacturing and other means and components utilized in this invention are widely known and used in the field of the invention described, and their exact nature or type is not necessary for an understanding and use of the invention by a person skilled in the art or science; therefore, they will not be discussed in significant detail. Furthermore, the various components shown or described herein for any specific application of this invention can be varied or altered as anticipated by this invention and the practice of a specific application or embodiment of any element may already be widely known or used in the art or by persons skilled in the art or science; therefore, each will not be discussed in significant detail.

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

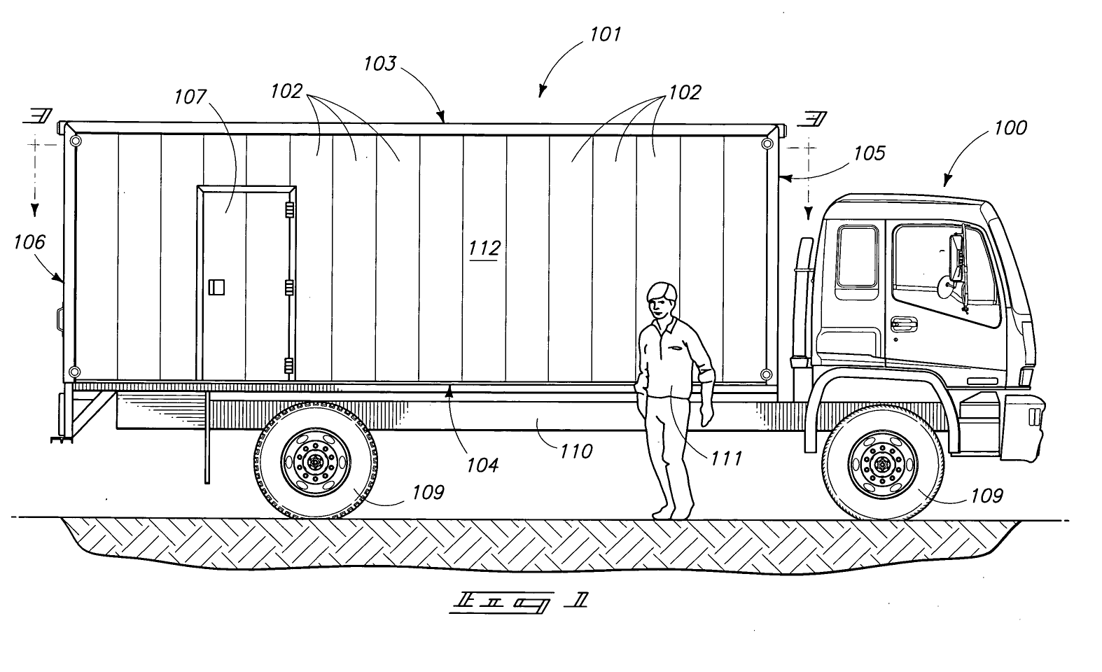

FIG. 1 is an elevation view of one embodiment of a mobile compartment system contemplated by this invention. FIG. 1 shows an operator 111 next to an embodiment of a mobile compartment system 101 mounted on a truck chassis 110 with a truck cab 100 powering the chassis and wheels 109. It will be appreciated by those of ordinary skill in the art that this invention is not limited to a compartment or truck box but instead may also include other types of compartments and enclosures, including travel trailers, horse trailers, railroad containers and any one of a number of others, all within the contemplation of this invention.

FIG. 1 illustrates panel members 102, door 107, rear end 106, front end 105, top end 103 and bottom 104 of the mobile compartment system 101. The first side 112 includes the door 107 cut therein.

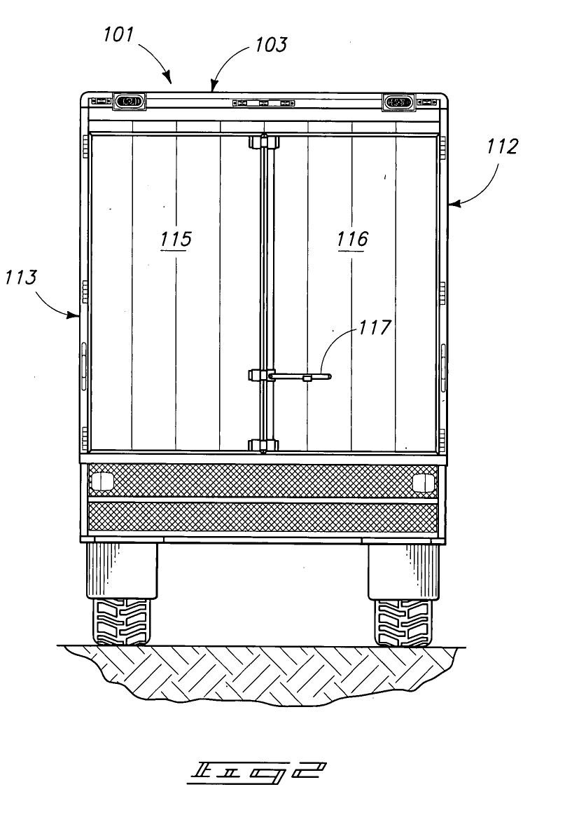

FIG. 2 is a side elevation view, and a rear of the truck and box configuration illustrated in FIG. 1. FIG. 2 illustrates how rear doors 115 and 116 to the vehicle or the truck box may be constructed out of panel members as part of the mobile compartment system 101. FIG. 2 illustrates top end 103, first side 112, second side 113, first door 115 and second door 116, with door lock and handle 117.

The strength and rigidity of the design of the mobile compartment system 101 provides for more consistent door frames which do not flex to the extent typically experienced in prior art systems, and a more consistent opening and closing of doors provided in the box.

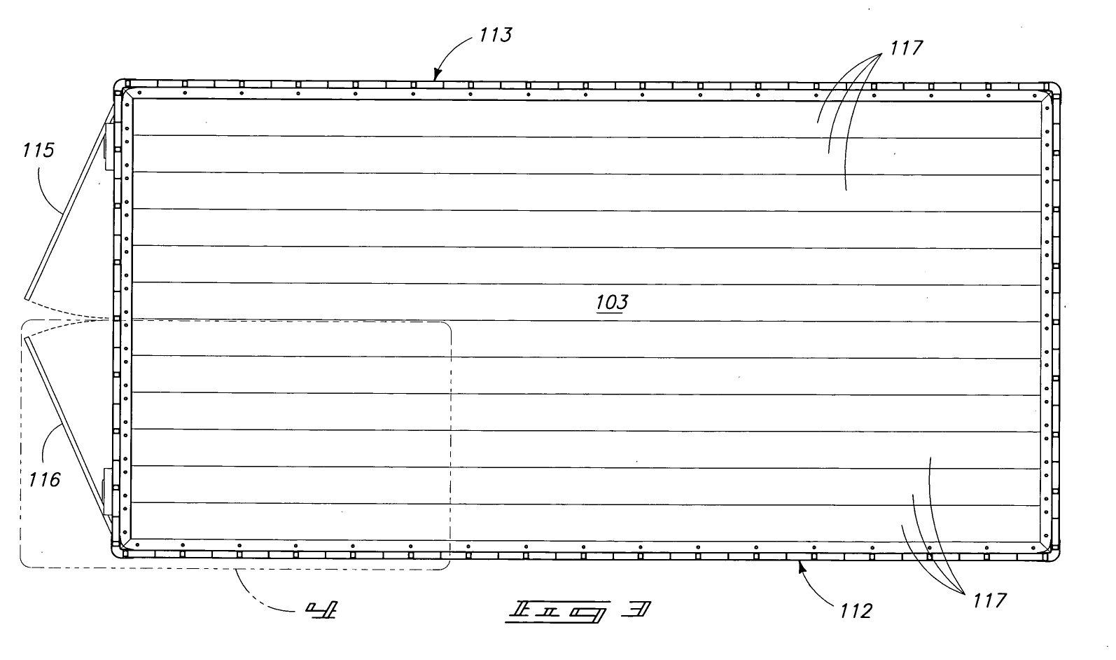

FIG. 3 is a top view of the mobile compartment system illustrated in FIG. 1. FIG. 3 is view 3-3 from FIG. 1 and illustrates how individual roof panel members 117 comprise the top surface 103, first side 112, second side 113, first rear door 115 and second rear door 116. It will be appreciated that roof panel members 117 may be the same or of different sizing than panel members 102, depending upon the application or embodiment.

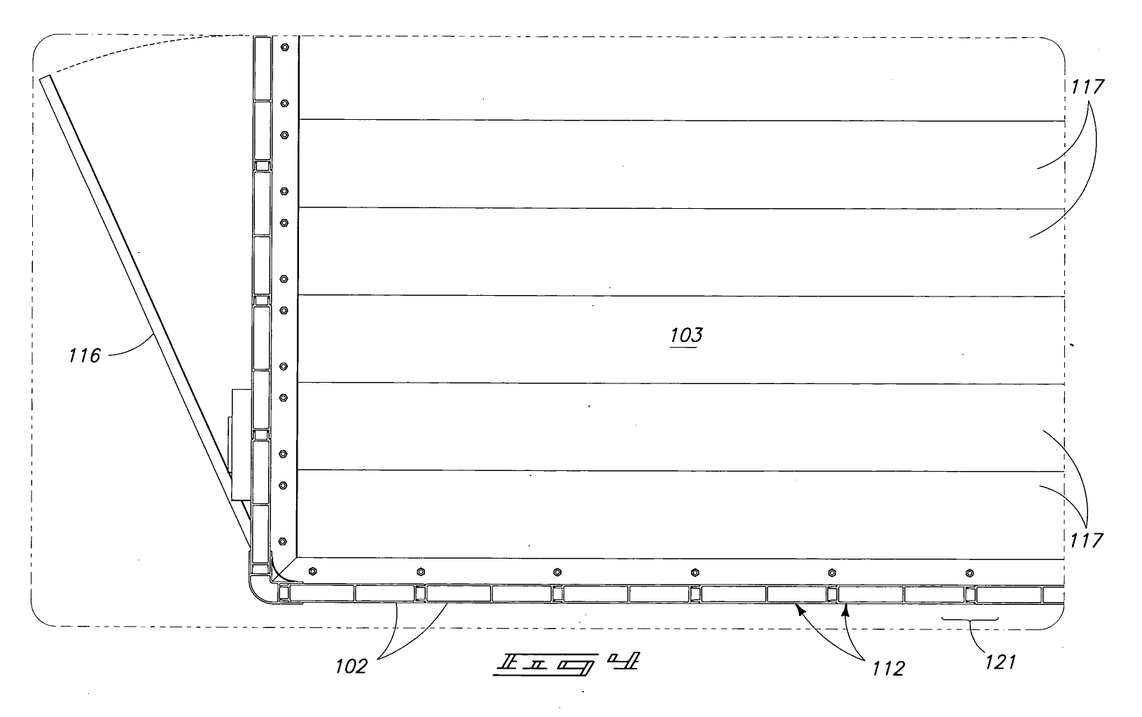

FIG. 4 is detail for from FIG. 3. FIG. 4 is detail 4 from FIG. 3 and more closely illustrates front panel members 102 at front side 112, with front panel members 102 being attached together by joint 121, roof panel member 117 on top side 103, and second door 116.

FIG. 4 illustrates how individual panel members are interlocked and operatively attached to one another, along with how that interacts with top side 103, or roof.

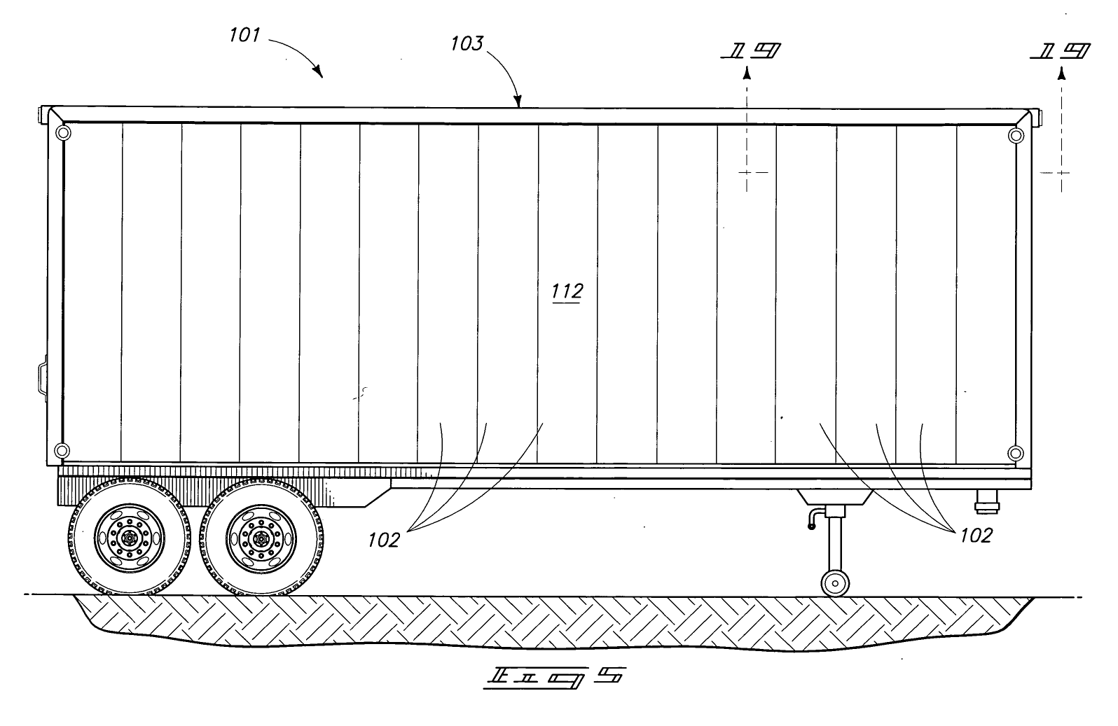

FIG. 5 is an elevation view of an embodiment of the mobile compartment system contemplated by this invention as part of a trailer. FIG. 5 shows a trailer that is not incorporated with the truck, but would be hooked up to a cab of some sort and pulled by a truck or other machine and illustrates mobile compartment system 101, top 103, first side 112 and panel members 102, all within trailer configuration. It will be appreciated by those of ordinary skill in the art that trailer configurations can come within any one of a number of different configurations all within the scope of this invention, such as travel trailers, horse trailers, storage trailers, trailers or compartments for placement on trains, and others.

FIG. 6 is a perspective view of one embodiment of a panel member which may utilized in practicing this invention. FIG. 6 shows one embodiment of an individual panel member 170 which may be utilized in practicing this invention. Panel member 170 includes first side 171, top end 177, bottom end 176, first tubular aperture 172 and second tubular aperture 173, with tubular divider 179 between the two apertures and partially defining the two apertures. As will be appreciated by those of ordinary skill in the art, the panel member 170 illustrated in FIG. 6 may easily be extruded out of any one of a number of different types of materials, such as aluminum or aluminum alloys, for weight, strength and/or more efficient manufacture. On a first side of panel member 170 is a male end connector 174 and on a second side of panel member 170 is female connector 175. Both male end connector 174 and female end connector 175 may be configured in any one of a number of different ways such that a male end connector 174 on one panel member may be interconnected with a female end connector on an adjacent panel member by either forcing the male end connector into the female end connector or by longitudinally sliding the female end connector over the male end connector to create the desired connection joint. This is shown more fully in later figures.

It may also be that in some embodiments that the male end connector may be the same configuration as the female end connector, still providing a joint that may be snapped/pushed/forced together and/or slid together, as described below in reference to other figures, all within the contemplation of this invention.

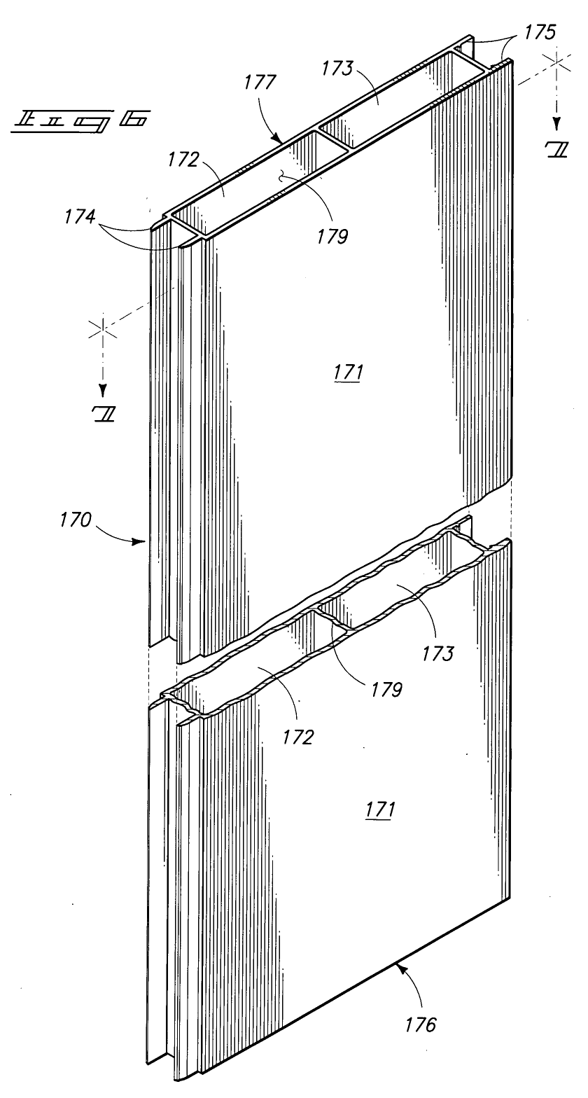

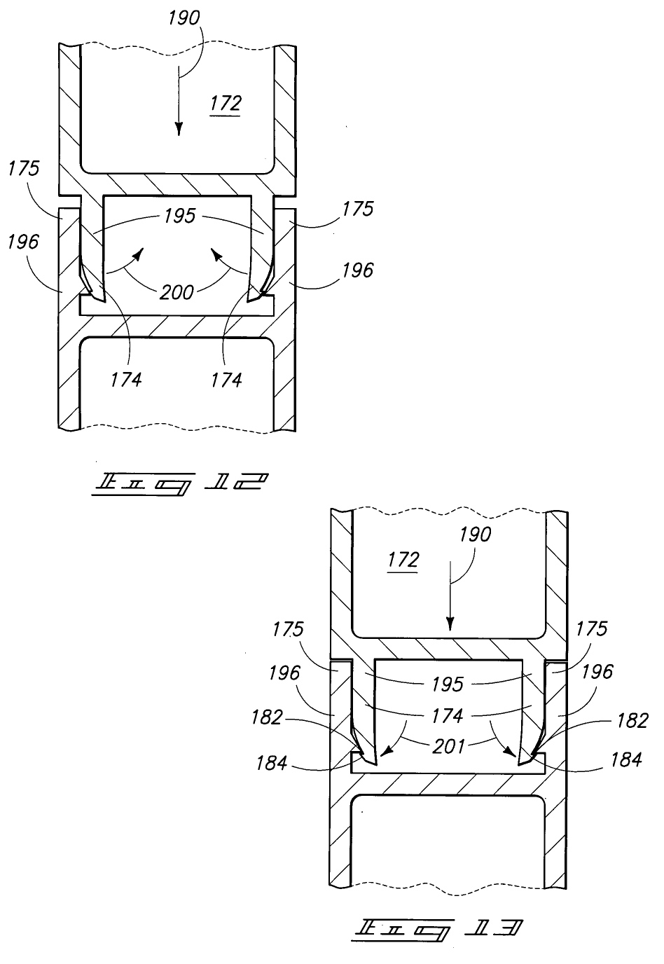

FIG. 7 is top cross-sectional view 7-7 from FIG. 6 of the panel member illustrated in FIG. 6. FIG. 7 is a top view cross-section 7-7 from FIG. 6 and illustrates panel member 170. FIG. 7 shows first tubular aperture 172, second tubular aperture 173, tubular divider 179, front side 171, rear side 180, female end connector 175 and male end connector 174. At the first side where the male end connector 174 is located, the approximate outer dimension of the prongs 195 is indicated by distance 183, which approximately matches the inner dimension of female end connector 175, with the inner dimension being represented by arrow 181 and represented distance between female end connectors 196. There is a barb 182 within female end connector which corresponds to an indent 184 in male end connector 174. When a male end connector is slid into a female end connector 175, the male prongs 195 will slightly defect and engage the indent 184 into the barbs 182 of the female end connector 175, shown and described more fully in reference to FIGS. 10 through 13.

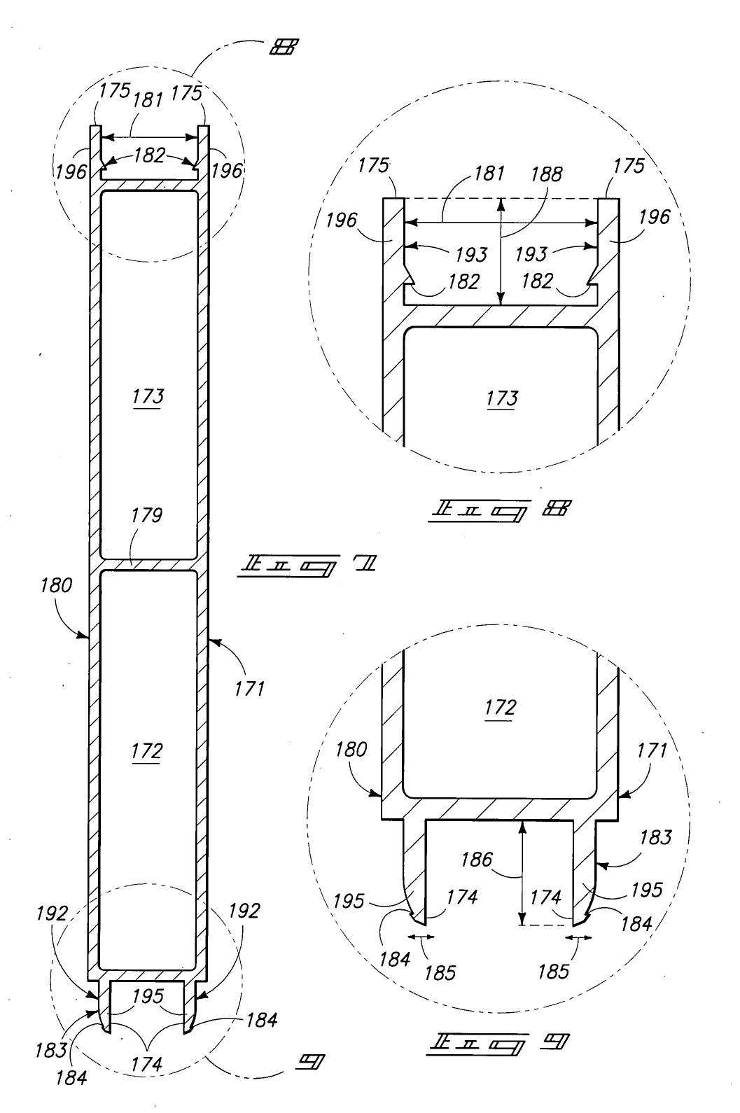

FIG. 8 is detail 8 from FIG. 7. FIG. 8 shows one embodiment of a female end connector 175, with female prongs 196, with inner surface 193, barbs 182 and distance between the inner surface 193 of the female prongs 196 being represented by arrow 181. The female end connector 175 is adjacent second tubular aperture 173.

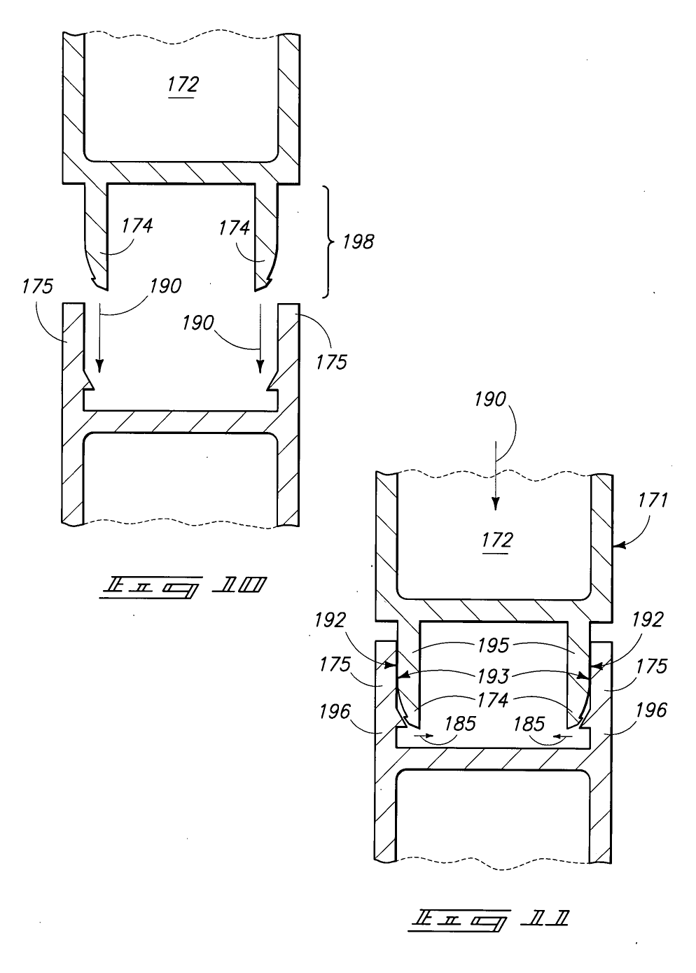

FIG. 9 is detail 9 from FIG. 7. FIG. 9 illustrates male end connector 174 with male prongs 195 with indents 184 and male prong length 186 corresponding to female depth 188 such that the male end connector can be inserted fully into the female end connector 175 and form what appears to be a continuous outer surface with a slight crease. FIG. 9 further shows front side 171, rear side 180, first tubular aperture 172 and arrows 185 representing slight deflection or movement that may occur at the ends of male prongs 195 to allow the indents 184 to interconnect with and be secured by barbs 182 within female end connector 175.

FIG. 10 is a cross-section view of one embodiment of how adjacent ends of panel members may be assembled together. FIG. 10 illustrates a male end connector 174 positioned for insertion into female end connector 175 as indicated by arrows 190, and insertion distance 198.

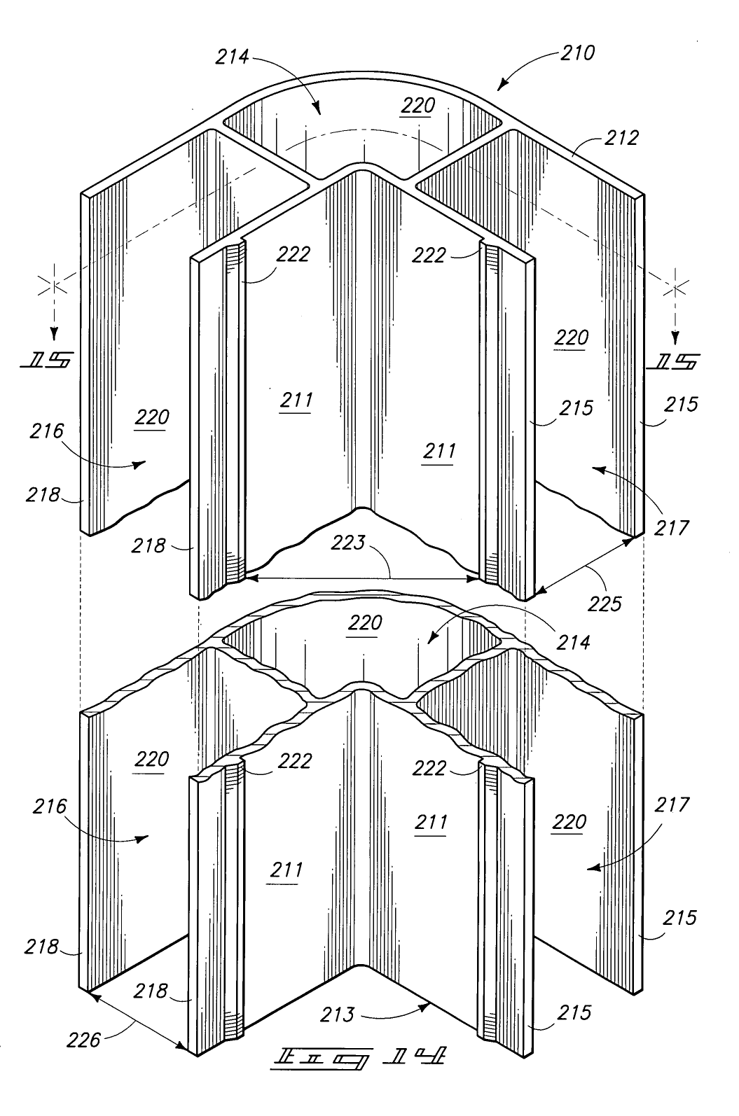

FIG. 11 is a cross-section view of the ends of two adjacent panel members partially assembled together. FIG. 11 shows male end connector 174 partially inserted within female end connector 175 as indicated by arrow 190 with male prongs 195 sliding within female prongs 196 such that the outer surface 192 of male prongs 195 approximates the inner surface 193 of female prongs 196. Arrows 185 indicate how male prongs 195 will flex or deflect slightly to allow interconnection, as further shown in other Figures.

FIG. 12 is a cross-section view of the ends of two adjacent panel members substantially pressed together. FIG. 12 shows male end connector 174 with male prongs 195 slid within and partially deflected with inwardly by the barb on female end connectors 196, with a deflection indicated by arrows 200.

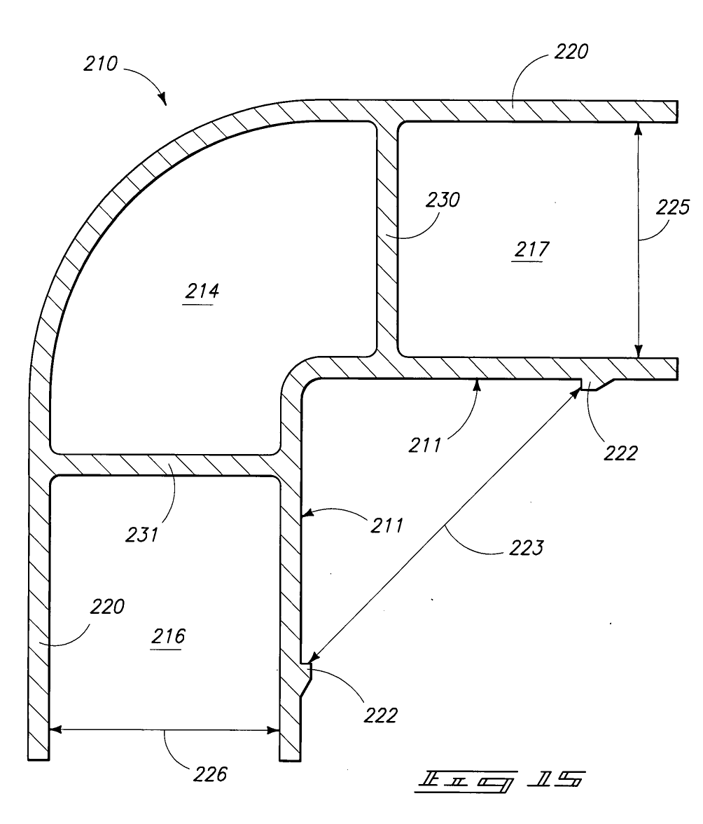

FIG. 13 is a cross-section view of two adjacent panel members operatively attached to one another, as contemplated by the invention. FIG. 13 illustrates male prongs 195 of male end connector 174 inserted within the female prong 196 of female end connector 175 with barbs 182 interconnecting with and attaching to indent 184 in male prongs 195. Arrows 201 show how the deflection has decreased in male prongs 195 so that the indents 184 may be firmly connected over barbs 182 to retain the adjacent panel members together.

It will be appreciated by those of ordinary skill in the art that while in the embodiment shown the male prongs 195 are shown as deflecting, this invention further contemplates and includes embodiments wherein the female prongs 196 may deflect outwardly and then release inward once the indent 184 is encountered.

It will also be appreciated by those of ordinary skill in the art and is shown in later Figures, how the male end connector of the first adjacent panel member may be slid into the female end connector of a second adjacent panel member such that the barb 182 fits within the indent 184 and allows relative sliding so the two can be positioned adjacent and operatively connected or attached by sliding as opposed to being forced and requiring deflection of the male prongs 195.

It will also be appreciated in those embodiments or applications of embodiment in which the adjacent panels are slid together, or forced together longitudinally, that soap, hairspray, or some other substance may be utilized to facilitate or lubricate the sliding.

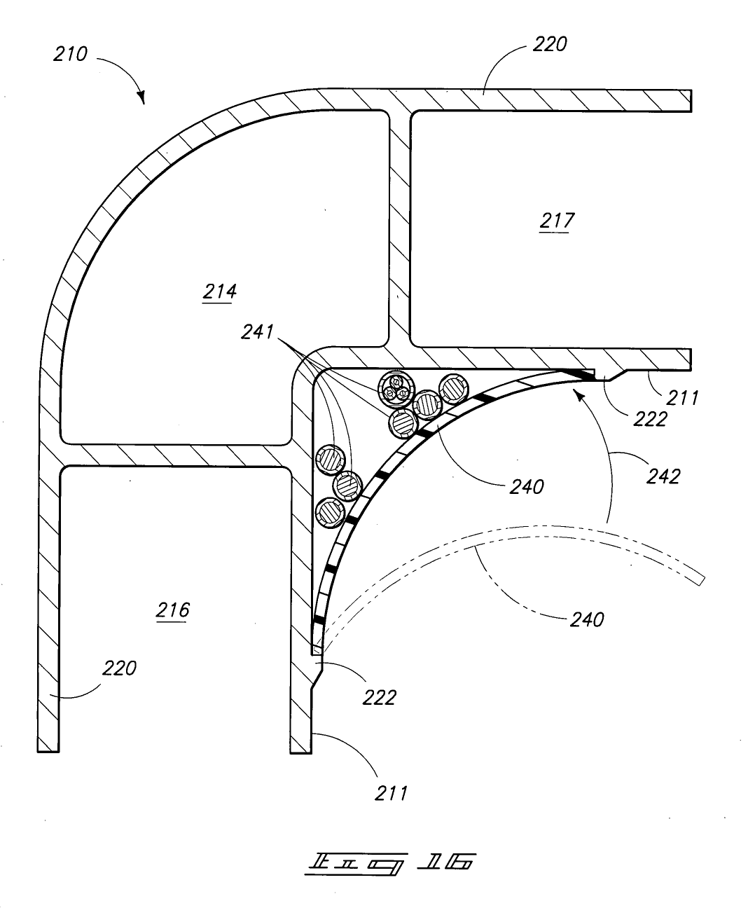

FIG. 14 is a perspective view of an embodiment of a corner member which may utilized in practicing this invention. FIG. 14 shows corner member 210 with top end 212 and bottom end 213, first side edge 218 and second side edge 215 with center aperture 214 and sidewall 222 in center aperture 214.

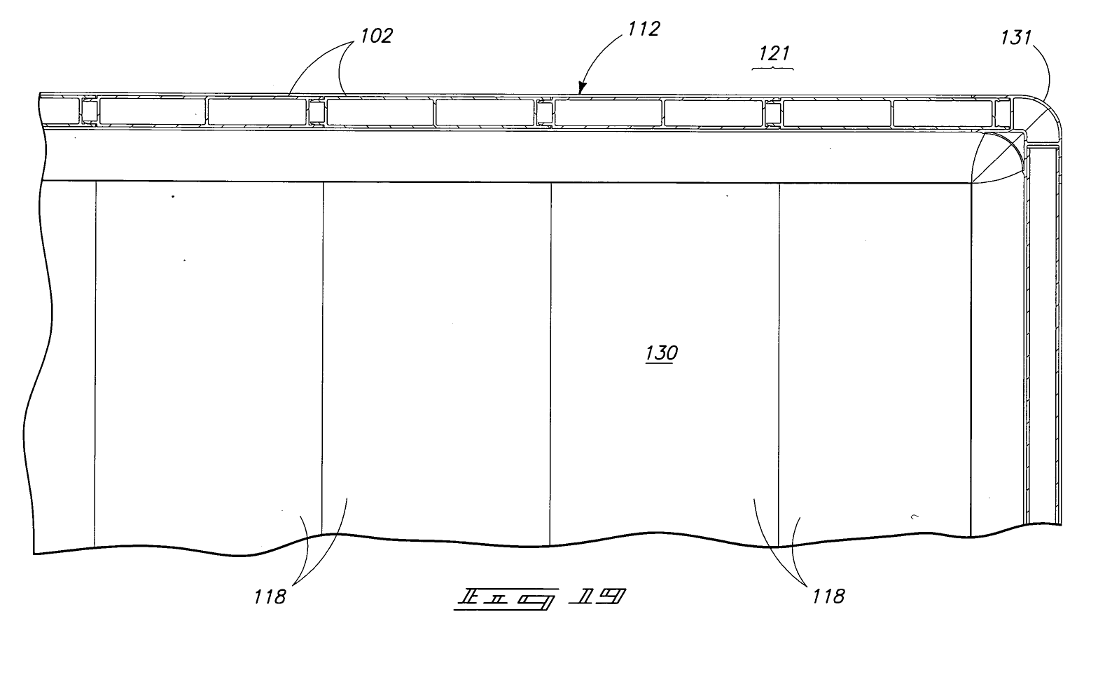

The inner surface 211 of corner member 210 includes two protrusions 222 or barbs, which provide a base against which a conduit or accessory wall may be inserted, as described in later Figures. The distance between protrusions 222 is indicated by arrow 223. A first side female connector aperture 216 is provided and a second side edge female aperture 217 is provided for interconnection of corner member 210 with panel member such as the panel member illustrated in FIG. 6. In the interconnection of a panel member such as that shown in FIG. 6 to corner member 210, FIG. 17 shows how a slide fit may be utilized with a female end connector such as female end connector 175 shown in FIG. 6.

It will also be appreciated by those of ordinary skill in the art that a corner member is used not only in a vertical sense in the boxes or trailers, but also will be used in a horizontal sense to provide the framework above panel sides and to interconnect side panel members with roof panel members. Inter-walls 220 within first side edge aperture 216 and sidewalls 221 within second side aperture 217 would be appropriately spaced to facilitate the attachment of panel member with two corner member 210 by tight fit. Alternatively, a glue may be inserted into first side edge aperture 216 or second side edge aperture 217 to provide bonding between panel members and corner member 210. It will be appreciated by those of ordinary skill in the art that any one of a number of additional fastening or attaching devices may be utilized within the contemplation of this invention, with no one in particular being required to practice this invention.

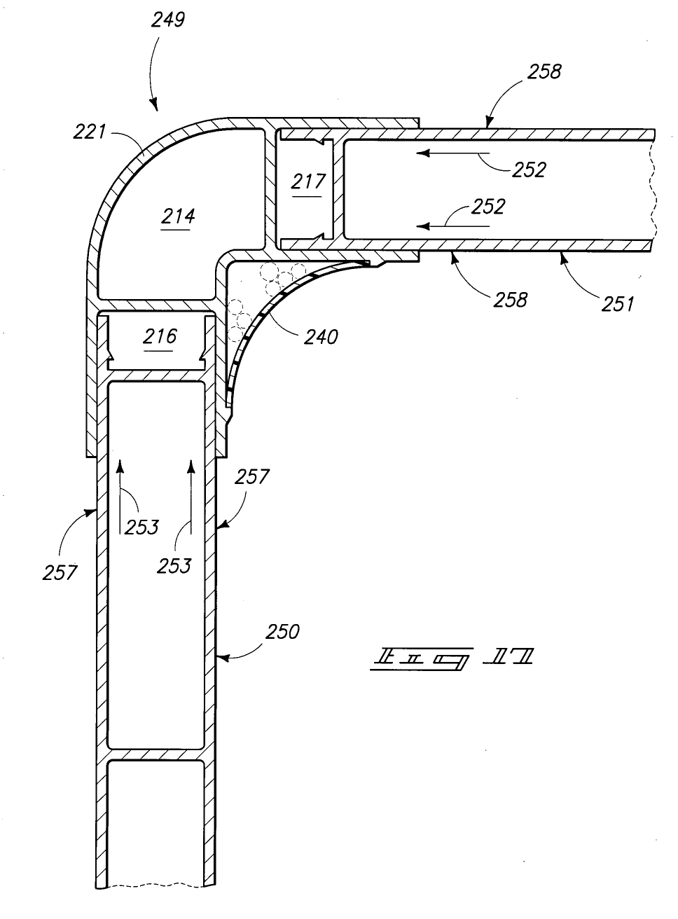

FIG. 15 is cross-section view 15-15 from FIG. 14. FIG. 15 illustrates core member 210, center aperture 214, outer wall 220, first side edge aperture, second side edge aperture 217, inner wall 211 and distance 223 between protrusions 222. Arrows 225 and 226 illustrate the distance between sidewalls of the first and second side edge apertures which would be appropriately sized to receive a panel member of like or similar outer dimensions for attachment thereto.

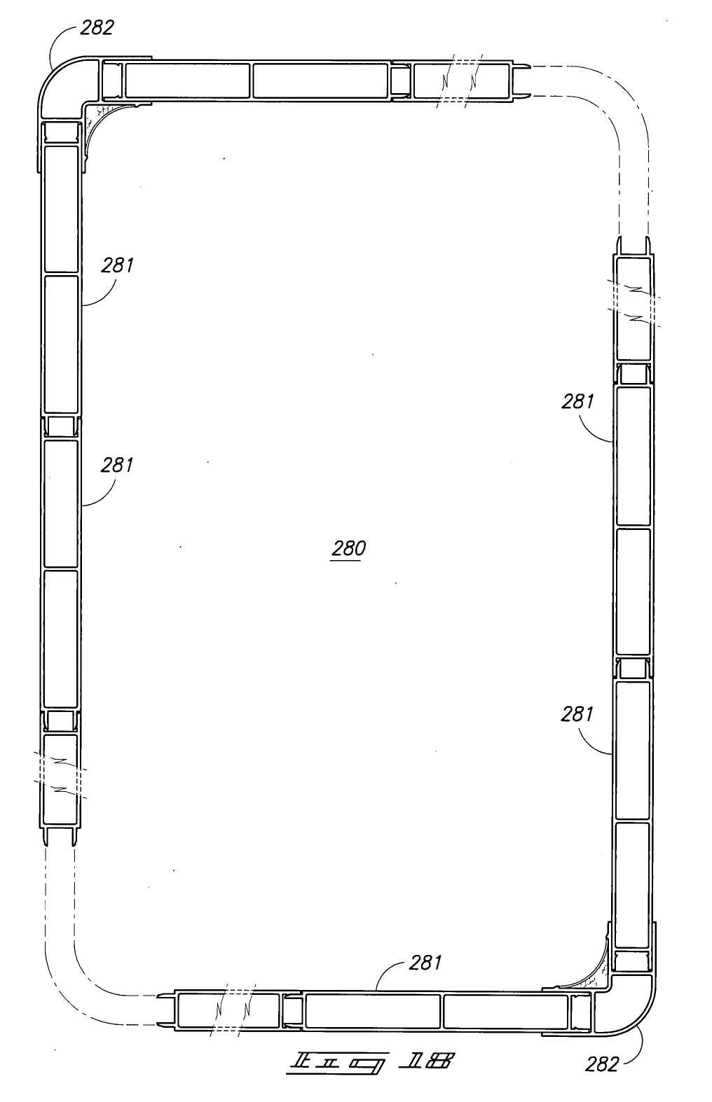

FIG. 16 is cross-section view 15-15 from FIG. 14, with an accessory conduit within the inner corner. FIG. 16 is a top cross-sectional view showing center aperture 214, first side edge aperture 216 and second side edge aperture 217, outer wall 221, protrusions 222, accessories or electrical wires 241 retained within the corner by accessory cover 240.

The accessory cover 240 will be semi-flexible or flexible material and will be easily put in place between protrusions 222 by forcing it inwardly and causing it to bend, therefore putting a bias within accessory cover 240 to hold it into place and to hold the accessory such as wire and other items in the corner. This may be easily removed and replaced and provides a much easier way to access, work on and/or alter the accessories and how the accessory wires are routed within the trailer compartment or box.

FIG. 17 is a cross-section view of the embodiment of a corner member illustrated in FIG. 15, with the embodiment of panel members illustrated in FIG. 6 operatively attached thereto. FIG. 17 illustrates outer wall 221, center aperture 214, first sided edge aperture 216, second side edge aperture 217, panel member 250 inserted within first sided edge aperture 216 and second panel member 251 inserted into second side edge aperture 217 as indicated by arrows 253 and 252 respectively. The outer sides 258 of second panel member 251 snuggly fit within second side edge aperture 217 for a snug fit and interconnection between second panel member 251 and corner member 249. Similarly, the outer sides 257 of first panel member 250 slide within first sided edge aperture 216 to snuggly fit within interconnect first panel member 250 to elbow member 249, as indicated by arrows 253.

FIG. 18 is a top view of the perimeter of a mobile compartment system contemplated by this invention before the top has been placed there over. FIG. 18 illustrates how multiple panel members 281 may be interconnected with other panel members and with corner members 282 to form the outer parameter of a box or compartment, with inner compartment 280.

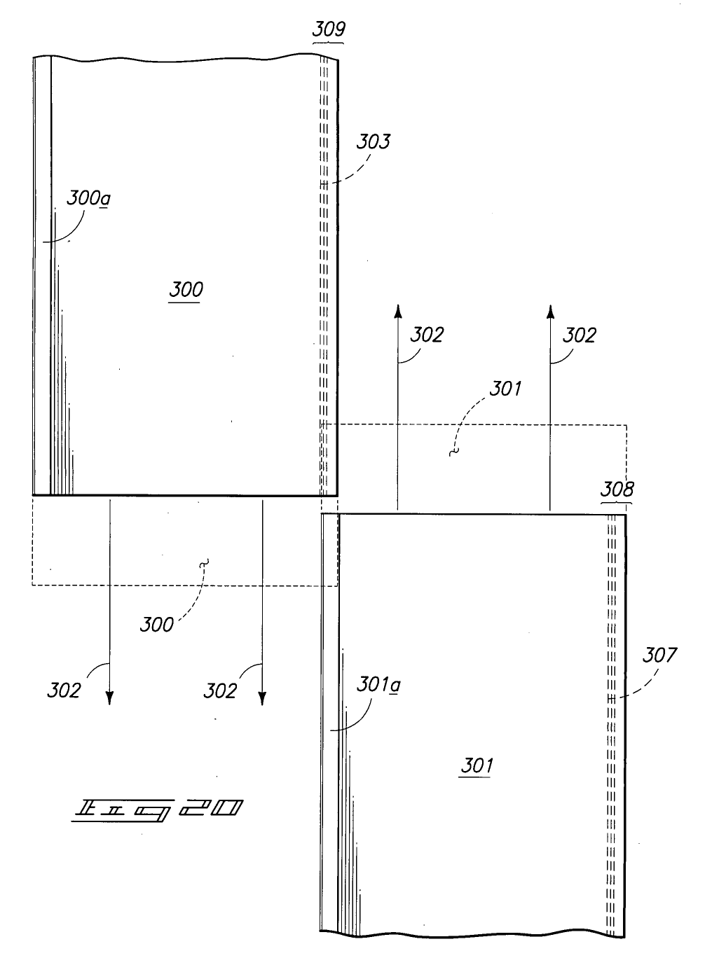

FIG. 19 is a partial top view of an embodiment of the invention including sidewalls and a base floor. FIG. 19 illustrates top side 130 comprised of roof panel members 118, front panel members 102 and side surface 112, with panel members 102 being interconnected as indicated by joint 121, and corner member 131 interconnecting panel members on a ninety degree (90°) angle.

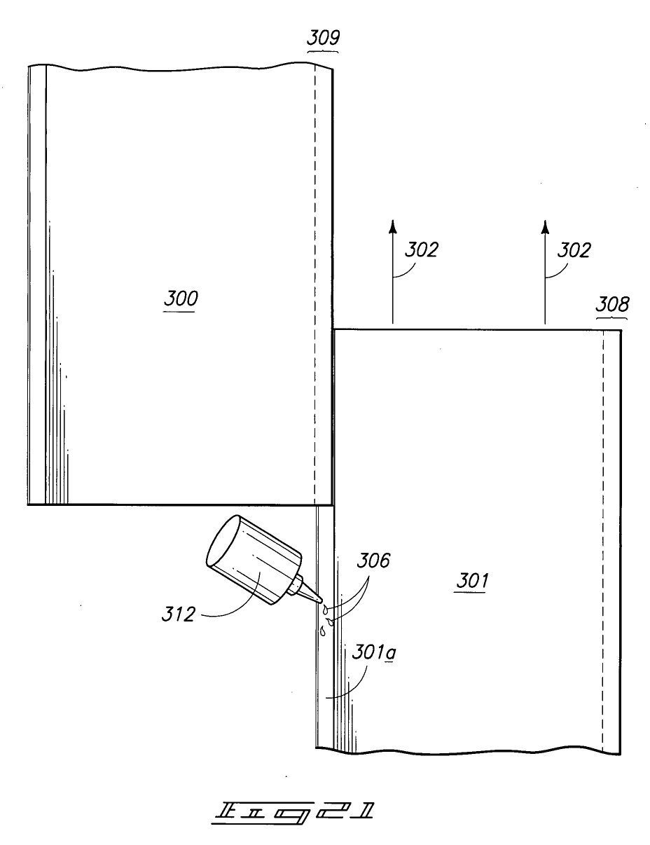

FIG. 20 is an exemplary elevation view illustrating how adjacent panel members illustrated in FIG. 6 may be longitudinally slid together. FIG. 20 illustrates first panel member 300 with female end connector 309 and second panel member 301 with male end connector 301A. Arrows 302 indicate how second panel member 301 may be slid relative to first panel member 300 once the male end connector 301A is aligned with the female end connector area 309 to provide relative movement and interconnection as an alternative way of connecting adjacent panel members, but still with the same male end connector and female end connector configurations or embodiments shown in FIG. 6 for instance. FIG. 20 further illustrates female end connector 308 in second panel member 301 and male end connector 300A and first panel member 300, both of which may be later attached to other adjacent panel members.

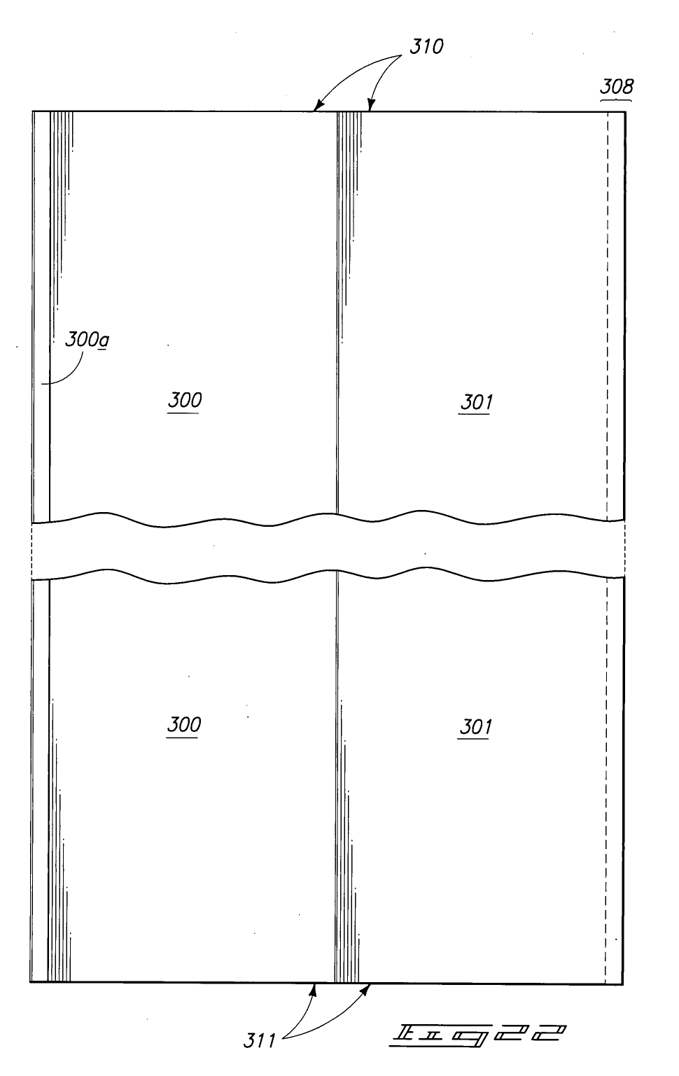

FIG. 21 is an elevation view of the adjacent panel members illustrated in FIG. 20 partially slid together. FIG. 21 illustrates the same general configuration as FIG. 20 only wherein second panel member 301 has been partially slid with an interlock with first panel 300. FIG. 21 further shows an additional alternative for additionally securing first panel member 300 to second panel member 301 by placing glue 306 from a glue container 307 onto male end connector 301A on second panel member 301 to provide additional bonding between the adjacent end connectors once they are aligned as desired. In most applications, glue will not be required, however lubricant or other surface preparation substance may be utilized, such as soap or hair spray.

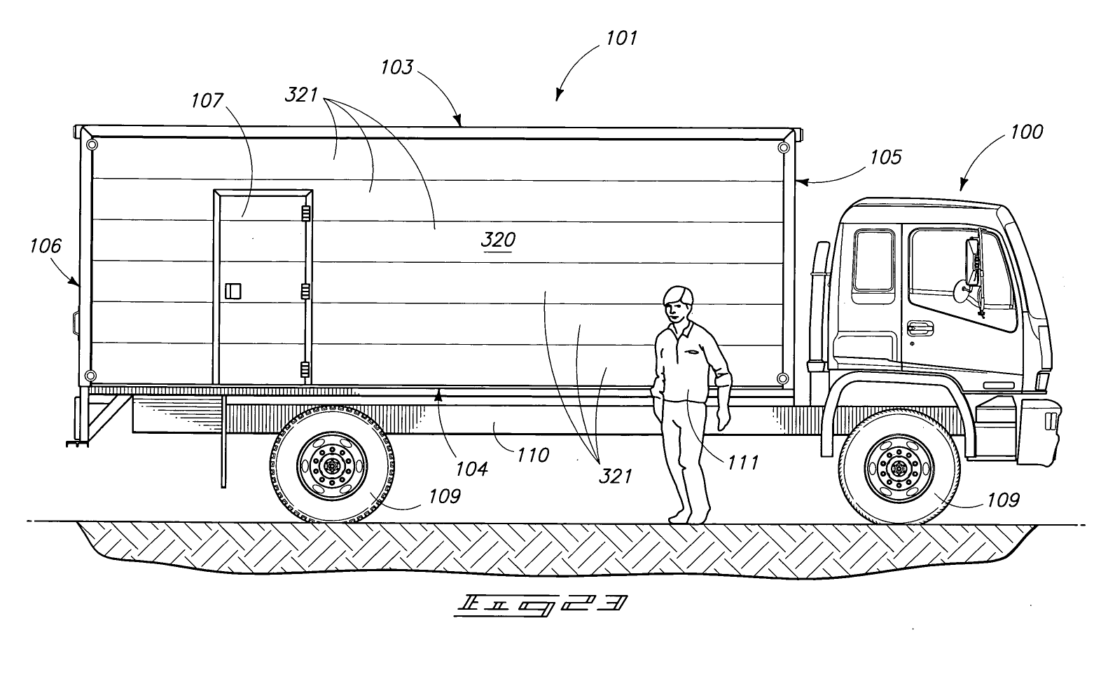

FIG. 22 is an elevation view of the panel members illustrated in FIG. 20 fully assembled or slid together. FIG. 22 shows first panel member 300 aligned with second panel member 307, with first panel member 300 still including male end connector 300A for interconnection with any additional panel members and female end connector 307 of second panel member 301 being connectable either to a corner member or to the male end connector portion of another adjacent panel member. Top end 310 and bottom end 311 are shown aligned as the adjacent panel members are operatively connected or attached

FIG. 23 is an elevation view of another embodiment of the invention wherein the wall panel members are horizontally oriented. FIG. 23 is the same view as FIG. 1 and like numbered items are the same as shown in FIG. 1, and will not therefore be discussed in detail herein. The difference between the embodiment shown in FIG. 23 and that in FIG. 1 are that the panel members or wall members are horizontal in FIG. 23 instead of vertical, which is another embodiment or way of practicing this invention. Front side 320 includes a plurality of panel members 321 to comprise the front wall.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted literally and in accordance with the doctrine of equivalents.

The invention claimed is:

1. A mobile compartment system comprising:
a first panel member and a second panel member, each with a first side, a second side, a first end, a second end, a first edge, a second edge, the first edge including a male edge connector and the second edge including a female edge connector; and
wherein the male edge connector of a first panel member and a female edge connector of the second panel member are configured to operatively attach together.

2. A mobile compartment system as recited in claim 1, and further wherein the male edge connector is configured to be operatively attached to the female edge connector by force fit.

3. A mobile compartment system as recited in claim 1, and further wherein the male edge connector of the first panel member is configured to be operatively attached to the female edge connector of the second panel member by longitudinally aligning the male edge connector at the first end of the first panel member with the female edge connector at the second end of the second panel member, such that the first panel member is slidable parallel to the second panel member to interlock the male edge connector of the first panel member with the female edge connector of the second panel member, which operably locks the first panel member to the second panel member and forms a contiguous wall panel.

4. A mobile compartment system as recited in claim 3, and which further comprises a third panel member with a first side, a second side, a first end, a second end, a first edge, a second edge, wherein a female edge connector of the third panel member is configured to be operatively attached to the male edge connector of the second panel member by longitudinally aligning the first end of the female edge connector with one of the first end and second end of the male edge connector of the second panel member, and sliding the third panel member parallel to the second panel member to interlock the female edge connector of the third panel member with the male edge connector of the second panel member, thereby operatively attaching the third panel member to the second panel member and forming a contiguous wall panel of the first panel member, the second panel member and the third panel member.

5. A mobile compartment system as recited in claim 1, and further wherein the first side is a male adapter and the second side is a female adapter.

6. A mobile compartment system as recited in claim 1, and further comprising glue between the first side of one of the plurality of panel members and the second side of an adjacent panel member.

7. A method of assembling a mobile compartment system, comprising the following:
providing a first panel member and a second panel member, each with a first side, a second side, a first end, a second end, a first edge, a second edge, the first edge including a male edge connector and the second edge including a female edge connector;
aligning the first panel member adjacent and substantially parallel to the second panel such that the male edge connector of the first panel member is adjacent the female edge connector of the second panel member; and
forcing the male edge connector of the first panel member into the female edge connector of the second panel member;
thereby operatively attaching the panel member to the second panel member.

8. A method of assembling a mobile compartment system as recited in claim 7, and further comprising:
providing a third panel member with a first side, a second side, a first end, a second end, a first edge, a second edge, the first edge including a male edge connector and the second edge including a female edge connector;
aligning the third panel member adjacent and substantially parallel to the second panel such that the female edge connector of the third panel member is adjacent the male edge connector of the second panel member; and
forcing the female edge connector of the third panel member over the male edge connector of the second panel member; and
thereby operatively attaching the panel member to the second panel member without an adhesive.

9. A method of assembling a mobile compartment system, comprising the following:
providing a first panel member and a second panel member, each with a first side, a second side, a first end, a second end, a first edge, a second edge, the first edge including a male edge connector and the second edge including a female edge connector;
longitudinally aligning the male edge connector at the first end of the first panel member with the female edge connector at the second end of the second panel member, such that the first panel member is slidable parallel to the second panel member to interlock the male edge connector of the first panel member with the female edge connector of the second panel member;
sliding the first panel member relative to the second panel member thereby interlocking the male edge connector of the first panel member to the female edge connector of the second edge connector, and thereby operably attaching the first panel member to the second panel member and forming a contiguous wall panel.

10. A method of assembling a mobile compartment system as recited in claim 9, and further comprising the following
providing a third panel member with a first side, a second side, a first end, a second end, a first edge, a second edge, wherein a female edge connector of the third panel member is configured to be operatively attached to the male edge connector of the second panel member;
longitudinally aligning the first end of the female edge connector with one of the first end and second end of the male edge connector of the second panel member;
sliding the third panel member parallel to the second panel member to interlock the female edge connector of the third panel member with the male edge connector of the second panel member, thereby operatively attaching the third panel member to the second panel member and forming a contiguous wall panel of the first panel member, the second panel member and the third panel member.
